(19) United States
(12) Patent Application Publication
(10) Pub. No.: US 2025/0102845 A1
(43) Pub. Date: Mar. 27, 2025

(54) WINDOW FILM AND METHOD FOR OPERATING THE SAME

(71) Applicant: ELECTRONICS AND TELECOMMUNICATIONS RESEARCH INSTITUTE, Daejeon (KR)

(72) Inventors: Gi Heon KIM, Daejeon (KR); Won Jae LEE, Daejeon (KR)

(21) Appl. No.: 18/747,739

(22) Filed: Jun. 19, 2024

(30) Foreign Application Priority Data
Jul. 20, 2023 (KR) 10-2023-0094507

(51) Int. Cl. G02F 1/133; E06B 9/24; G02F 1/1334; G02F 1/169

(52) U.S. Cl. CPC G02F 1/13306; E06B 9/24; G02F 1/1334; G02F 1/169; E06B 2009/2464; G02F 2201/44

(57) ABSTRACT

Provided is a variable-transmittance window film capable of being operated in four different colors, and the window film of the present invention includes a first film, a second film spaced apart from the first film, a third film interposed between the first film and the second film, a suspended particle layer between the first film and the third film, and a polymer dispersed liquid crystal layer between the second film and the third film, wherein the polymer dispersed liquid crystal layer includes a dye having a second color complementary to a first color of the suspended particle layer.

### CROSS-REFERENCE TO RELATED APPLICATIONS

This U.S. non-provisional patent application claims priority under 35 U.S.C. § 119 of Korean Patent Application No. 10-2023-0094507, filed on Jul. 20, 2023, the entire contents of which are hereby incorporated by reference.

### BACKGROUND

The present disclosure herein relates to a window film, and more particularly, to a variable-transmittance window film capable of being operated in four different colors.

A suspended particle device (SPD) has been examined for application in a manner of controlling the amount of light transmitted in variable-transmittance devices such as displays, smart windows, and automotive sunroofs, filters for optical fibers, and applications such as toys, sun visors, eyewear, and mirrors.

The SPD is used in various fields such as smart windows of transportation devices such as automobiles and building windows due to its large area, shape control, continuous transmission control, and low power consumption, but there is a restriction in use of the SPD due to the prominent blue color thereof in the absence of an electric field.

### SUMMARY

The present disclosure provides a window film having an opaque state in a black color.

The present disclosure also provides a method for operating a window film, the method capable of controlling the state of the film in four different colors.

An embodiment of the inventive concept provides a window film including a first film, a second film spaced apart from the first film, a third film interposed between the first film and the second film, a suspended particle layer between the first film and the third film, and a polymer dispersed liquid crystal layer between the second film and the third film, wherein the polymer dispersed liquid crystal layer may include a dye having a second color complementary to a first color of the suspended particle layer.

In an embodiment of the inventive concept, there is provided a method for operating a window film, wherein the window film includes a first film, a second film spaced apart from the first film, a third film interposed between the first film and the second film, a suspended particle layer between the first film and the third film, and a polymer dispersed liquid crystal layer between the second film and the third film, and the method includes a first step of controlling the application of a first electric field to the suspended particle layer, and a second step of controlling the application of a second electric field to the polymer dispersed liquid crystal layer.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view illustrating a window film according to the present invention; and

FIGS. 2, 3, 4, and 5 are cross-sectional views illustrating a window film according to an embodiment of the present invention.

### DETAILED DESCRIPTION

In order to facilitate sufficient understanding of the configuration and effects of the present invention, preferred embodiments of the inventive concept will be described with reference to the accompanying drawings. However, the present invention is not limited to the embodiments set forth below, and may be embodied in various forms and modified in many alternate forms. Rather, the present embodiments are provided so that the disclosure of the present invention will be thorough and complete, and will fully convey the scope of the present invention to those skilled in the art to which the inventive concept pertains.

In the present specification, when an element is referred to as being on another element, it means that the element may be directly formed on the other element, or that a third element may be interposed therebetween. Also, in the drawings, the thickness of elements are exaggerated for an effective description of technical contents. Like reference numerals refer to like elements throughout the specification.

Embodiments described in the present specification will be described with reference to cross-sectional views and/or plan views which are ideal illustrations of the present invention. In the drawings, regions illustrated have schematic properties, and the shapes of the regions illustrated in the drawings are intended to exemplify specific shapes of regions of a window film and are not intended to limit the scope of the present invention. Although the terms first, second, and the like are used in various embodiments of the present specification to describe various elements, these elements should not be limited by these terms. These terms are only used to distinguish one element from another. The embodiments described and exemplified herein also include the complementary embodiments thereof.

The terms used herein are for the purpose of describing embodiments and are not intended to be limiting of the present invention. In the present specification, singular forms include plural forms unless the context clearly indicates otherwise. As used herein, the terms ‘comprises’ and/or ‘comprising’ are intended to be inclusive of the stated elements, and do not exclude the possibility of the presence or the addition of one or more other elements.

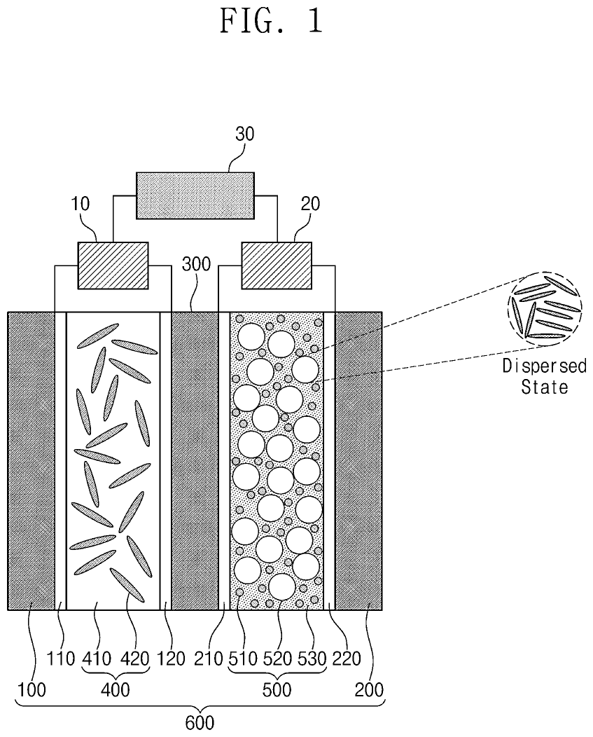

FIG. 1 illustrates a window film according to an embodiment of the present invention.

Referring to FIG. 1, a window film 600 may include a first film 100, a second film 200, a third film 300, a suspended particle layer 400 between the first film and the third film, and a polymer dispersed liquid crystal layer 500 between the second film 200 and the third film 300. The suspended particle layer 400 may have a first color. The polymer dispersed liquid crystal layer 500 may have a second color complementary to the first color. For example, the first color may be a blue color, and the second color may be an orange color. As an embodiment of the present invention, the polymer dispersed liquid crystal layer 500 may include a dye 510 having the second color.

The window film 600 may further include a first conductive film 110 between the first film 100 and the suspended particle layer 400, a second conductive film 120 between the third film 300 and the suspended particle layer 400, a third conductive film 210 between the third film 300 and the polymer dispersed liquid crystal layer 500, and a fourth conductive film 220 between the second film 200 and the polymer dispersed liquid crystal layer 500. Each of the first to fourth conductive films may include at least one selected from the group consisting of indium zinc oxide (ITO), silver nanowire, aluminum, carbon nanotube (CNT), graphene, PEDOT:PSS, polyaniline, and polythiophene.

A first control unit 10 configured to apply a first electric field to the suspended particle layer 400 may be connected to the first conduction film 110 and the second conduction film 120. A second control unit 20 configured to apply a second electric field to the polymer dispersed liquid crystal layer 500 may be connected to the third conductive film 210 and the fourth conductive film 220. The first control unit 10 and the second control unit 20 may be connected to a film control unit 30. Through the film control unit 30, the first control unit 10 and the second control unit 20 may operate independently of each other.

Each of the first to third films 100, 200, and 300 may include a transparent polymer. The first to third films 100, 200, and 300 may be configured to support the suspended particle layer 400 and the polymer dispersed liquid crystal layer 500. The third film 300 may physically connect the suspended particle layer 400 and the polymer dispersed liquid crystal layer 500 to each other by being interposed therebetween.

The suspended particle layer 400 may include a dispersion 410 containing an organic fluid or organic gel, and suspended particles 420 dispersed in the dispersion. In order to supplement the impact resistance of the suspended particle layer 400, a mixture of ultraviolet-curable oligomers and monomers may be mixed with the suspended particle layer 400 and photo-cured to form a polymer matrix around the suspended particles 420. If the first electric field is not applied to the suspended particle layer 400, the suspended particles 420 dispersed in the dispersion 410 may be randomly positioned due to the Brownian motion. Light incident on the suspended particle layer 400 may be absorbed or reflected depending on the concentration, characteristics, and SPD structure of the suspended particles 420. If the first electric field is not applied, the suspended particle layer 400 may be opaque or translucent.

If the first electric field is applied to the suspended particle layer 400, the suspended particles 420 may be arranged in the direction of the first electric field, so that the incident light may pass through the suspended particle layer 400. In other words, the suspended particle layer 400 is switched to a transparent state.

The polymer dispersed liquid crystal layer 500 may further include a polymer layer 530 and liquid crystals 520 dispersed in the polymer layer 530. The polymer layer 530 may include a photoinitiator, an ultraviolet-curable polymer precursor, and a dispersant. The polymer dispersed liquid crystal layer 500 may contain approximately 80 parts by weight to approximately 120 parts by weight of the liquid crystals based on 100 parts by weight of a curable polymer. In order to improve the curing rate by an exposure machine during ultraviolet curing, an ultraviolet-curable polymer composition may be mixed with one or more types of photoinitiators and applied. The weight of the photoinitiator may be approximately 0.5 parts by weight to 10 parts by weight based on 100 weights of the cured polymer. For the ultraviolet curing according to the present invention, light with a wavelength of approximately 250 nm to approximately 400 nm may be used, and photocuring energy of approximately 50 mJ to approximately 2000 mJ may be used.

An ultraviolet curing agent may include at least one of 1-hydroxy-cyclohexyl-phenyl-ketone (Irgacure 9070), 2-methyl-1[4-(methylthio)phenyl]-2-morpholinopropane-1-one (Irgacure 184C), 2-hydroxy-2-methyl-1-phenyl-propane-1-one (Darocur 1173), an initiator (Irgacure 500) in which 50 wt % of Irgacure 184C and 50 wt % of benzophenone are mixed, an initiator (Irgacure 1000) in which 20 wt % of Irgacure 184 and 80 wt % of Irgacure 1173 are mixed, 2-hydroxy-1-[4-(2-hydroxyethoxy)phenyl]-2-methyl-1propanone (Irgacure 2959), methylbenzoylformate (MBF), alpha, alpha-dimethoxy-alpha-phenylacetophenone (Irgacure 651), 2-benzyl-2-(dimethylamino)-1-[4-(morpholinyl) phenyl]-1-butanone (Irgacure 369), an initiator (Irgacure 1300) in which 30 wt % of Irgacure 369 and 70 wt % of Irgacure 651 are mixed, diphenyl (2,4,6-trimethylbenzoyl)-phosphine oxide (Darocur TPO), an initiator (Darocur 4265) in which 50 wt % of Darocur TPO and 50 wt % of Darocur 1173 are mixed, phosphine oxide, phenyl bis(2,4,6-trimethyl benzoyl (Irgacure 819), 2-hydroxy-2-methyl-1-phenyl-propane-1-one (Darocur 1173), an initiator (Irgacure 2005) in which 5 wt % of Irgacure 819 and 95 wt % of Darocur 1173 are mixed, an initiator (Irgacure 2010) in which 10 wt % of Irgacure 819 and 90 wt % of Darocur 1173 are mixed, an initiator (Irgacure 2020) in which 20wt % of Irgacure 819 and 80 wt % of Darocur 1173 are mixed, bis (eta5-2,4-cyclopentadien-1-yl) bis [2,6-difluoro-3-(1H-pyrrol-1-yl)phenyl]titanium (Irgacure 784), an initiator (HSP 188) containing benzophenone, 1-hydroxy-cyclohexylphenyl-ketone (CPA), or 2,4,6,-trimethylbenzoyl-diphenyl-phosphineoxide (Darocur TPO).

An ultraviolet-curable polymer may be a polymer which is cured by ultraviolet light, and may include an amorphous or semi-crystalline monomer or oligomer which is cured by ultraviolet light. As an example, the ultraviolet-curable polymer may include at least one of a urethane acrylate oligomer (molecular weight, 1000 to 4000), 2(2-ethoxyethoxy) ethyl acrylate (EOEOEA), isobornyl acrylate (IOBA), triethylopropane triacrylate (TMPTA), tri(propylene glycol) diacrylate (TPGDA), penthaerithritol triacrylate (PETA), hydroxyethyl acrylate (HEA), trimethylolpropane ethoxylate triacrylate (TMPEOTA), 2-phenoxyethyl acrylate (2-PEA), methyl methacrylate (MMA), methacrylate (MA), tetrahydrofurfuryl acrylate, tri(propylene glycol) glycerolate diacrylate (TPGDA), vinylacrylate (VA), ethylene glycol dimethacrylate (EGDA), an epoxy acrylate monomer or oligomer, 1,6-hexandiol diacrylate (HAD), 2-hydroxyethyl methacrylate (2-HEMA), 2-ethylheyxyl acrylate, ethylene glycol diacrylate, trimethylolpropane dially ether, urethane diacrylate, 2-phenoxyethyl acrylate, or tetrahydrofurfuryl acrylate.

The liquid crystals 520 may have a thin and long rod shape. If the second electric field is applied to the polymer dispersed liquid crystal layer 500, the molecular arrangement changes in the direction of the electric field. Typically, there are no restrictions on the characteristics of the liquid crystals, but as an example, the liquid crystals according to the present invention may have a flow viscosity (mm²/s) of approximately 15 to approximately 100, a refractive index anisotropy of approximately 0.10 to approximately 0.30, and a dielectric anisotropy (1.0 kHz) of approximately +2.0 to approximately +50.0.

The dye 510 included in the polymer dispersed liquid crystal layer 500 may be prepared by mixing two or more dyes having a chemical structure with excellent miscibility with a polymer and liquid crystals. For example, a mixture of a yellow dye and a red dye may be used to impart the second color (e.g., an orange color) to the polymer dispersed liquid crystal layer 500. The concentration of the dyes included in the polymer dispersed liquid crystal layer 500 may be approximately 0.01 wt % to approximately 10 wt % based on the weight of liquid crystals.

The yellow dye may have a structure of [Formula 1] below.

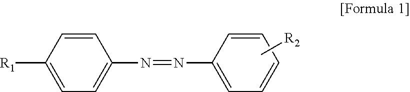

In Formula 1 above, R₁ may be —N(CH₃)₂, —N(C₂H₅)₂, or —N(X)₂. The X may be an alkyl chain having 3 or more carbon atoms, and in Formula 1 above, R₂ may be —H, —CH₃, —C₂H₅, a linear alkyl group having 3 or more carbon atoms, a branched alkyl group having 3 or more carbon atoms, a linear alkene having 3 or more carbon atoms, a branched alkene having 3 or more carbon atoms, or one or more aromatic groups.

The red dye may have a structure of [Formula 2] or a structure of [Formula 3] below.

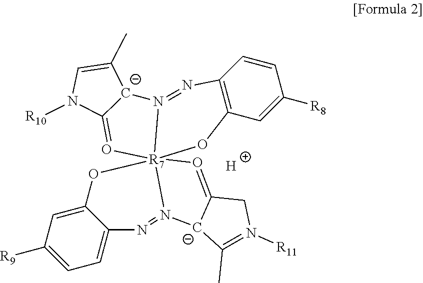

In Formula 2 above, R₇ may be one among Cr, Mo, W, Mn, V, Nb, and Ta, and R₈ R₉ R₁₀, and R₁₁ may each independently be —NO₂, —NH₃, —NHCH₃, —NC₄H₁₀, —NC₂H₆, —N(an alkyl chain having 3 or more carbon atoms), or one or more aromatic groups.

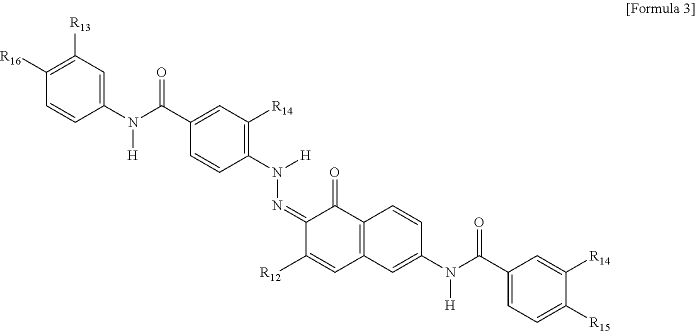

In Formula 3 above, R₁₂ may be either —SO₃Na or —SO₃H, R₁₃ may be either —COOH or —COONa, R₁₄ and R₁₅ may each independently be —H, —CH₃, —C₂H₅, or one among an alkyl group having 3 or more carbon atoms, a branched alkyl group having 3 or more carbon atoms, a linear alkene having 3 or more carbon atoms, a branched alkene having 3 or more carbon atoms, —NC₄H₁₀, —NC₂H₆, —NHCH₃, —NH₂, —N (an alkyl chain having 3 or more carbon atoms), and one or more aromatic group, and R₁₆ may be one among —H, —OH, —SO₃H, and —COOH.

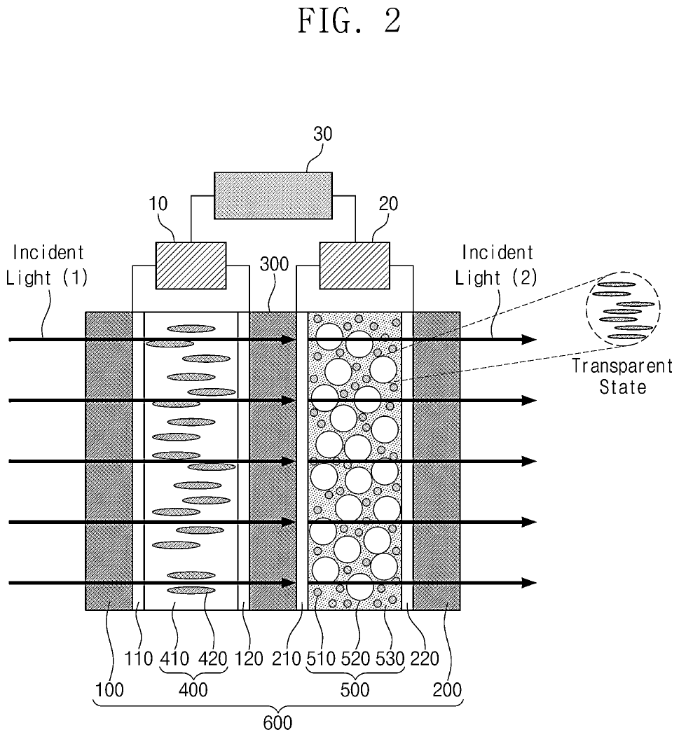

FIG. 2 to FIG. 5 show the operation state of a window film depending on the application of the first electric field and the second electric field.

FIG. 2 illustrates a state in which the first electric field is applied through the first control unit 10, and the second electric field is also applied through the second control unit 20. Since the first electric field is applied, the suspended particles 420 are arranged in the direction of the electric field, so that the suspended particle layer 400 may become transparent. Since the second electric field is applied, molecules of the liquid crystal 520 are arranged in the direction of the electric field, so that the polymer dispersed liquid crystal layer 500 may become transparent. Incident light 1 incident on the first film 100 may pass through the suspended particle layer 400. The incident light 2 that has passed through the suspended particle layer 400 may pass through the polymer dispersed liquid crystal layer 500. That is, the window film 600 becomes transparent.

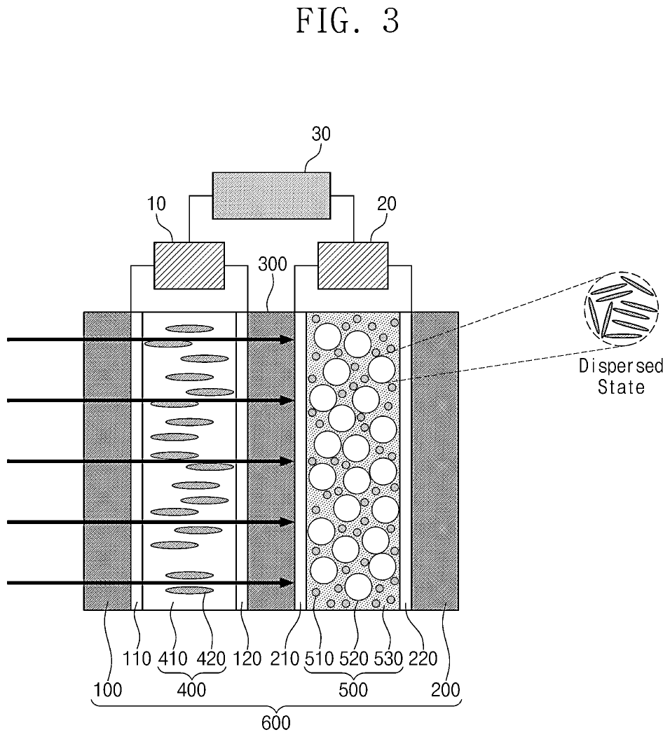

FIG. 3 illustrates a state in which the first electric field is applied through the first control unit 10, and the second electric field is not applied through the second control unit 20. Since the first electric field is applied, the suspended particles 420 are arranged in the direction of the electric field, so that the suspended particle layer 400 may become transparent. Since the second electric field is not applied, the liquid crystal molecules 520 are arranged randomly, so that the polymer dispersed liquid crystal layer 500 may become opaque or translucent. Finally, the window film 600 may become opaque or translucent in the second color.

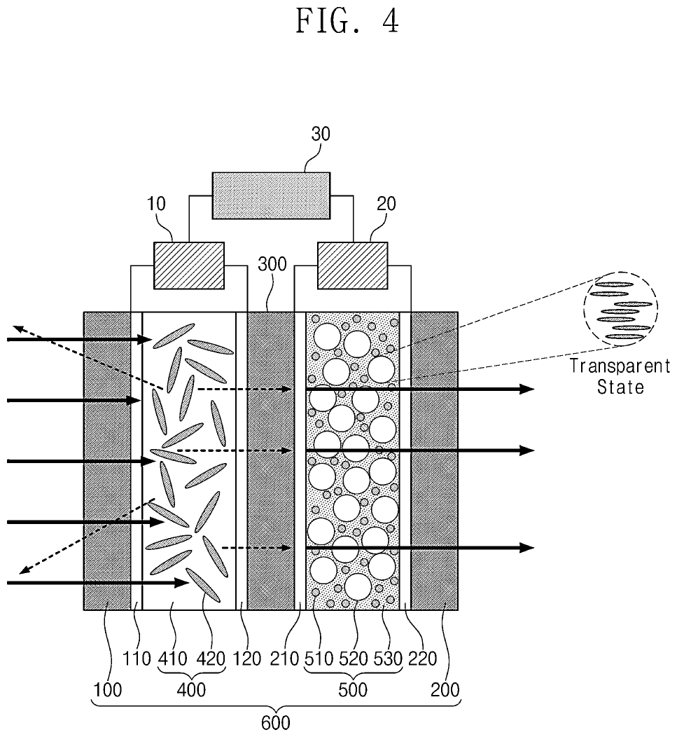

FIG. 4 illustrates a state in which the first electric field is not applied through the first control unit 10, and the second electric field is applied through the second control unit 20. Since the first electric field is not applied, the suspended particles 420 are arranged randomly, so that the suspended particle layer 400 may become opaque or translucent. Since the second electric field is applied, molecules of the liquid crystal 520 are arranged in the direction of the electric field, so that the polymer dispersed liquid crystal layer 500 may become transparent. Finally, the window film 600 may become opaque or translucent in the first color.

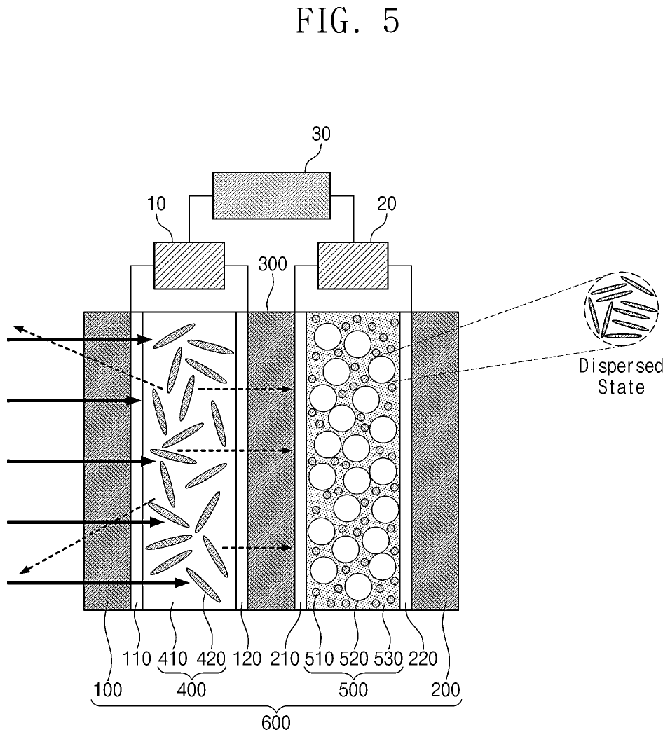

FIG. 5 illustrates a state in which the first electric field is not applied through the first control unit 10, and the second electric field is also not applied through the second control unit 20. Since the first electric field is not applied, the suspended particles 420 are arranged randomly, so that the suspended particle layer 400 may become opaque or translucent. Since the second electric field is not applied, the liquid crystal molecules 520 are arranged randomly, so that the polymer dispersed liquid crystal layer 500 may become opaque or translucent. Finally, the window film 600 may become opaque or translucent in a black color, as a result of the mixture of the first color and the second color, which are complementary colors.

According to the present invention, a window film includes a polymer liquid crystal layer containing a dye having a second color complementary to a first color of a suspended particle layer, and thus, may be operated in an opaque or translucent state in a black color in the absence of an electric field.

According to the present invention, depending on the application of a first electric field and a second electric field, the window film may be operated in four different colors of an opaque or translucent state in a black color, an opaque or translucent state in a first color, an opaque or translucent state in a second color, and a transparent state.

Although the present invention has been described in detail with reference to preferred embodiments, the present invention is not limited to the above-described embodiments, and various modifications and changes may be made by those skilled in the art within the technical spirit and scope of the present invention.

What is claimed is:

1. A window film comprising:
a first film;
a second film spaced apart from the first film;
a third film interposed between the first film and the second film;
a suspended particle layer between the first film and the third film; and
a polymer dispersed liquid crystal layer between the second film and the third film, wherein the polymer dispersed liquid crystal layer includes a dye having a second color complementary to a first color of the suspended particle layer.

2. The window film of claim 1, further comprising:
a first conductive film interposed between the first film and the suspended particle layer;
a second conductive film interposed between the third film and the suspended particle layer;
a third conductive film interposed between the third film and the liquid crystal layer; and
a fourth conductive film interposed between the second film and the liquid crystal layer.

3. The window film of claim 2, further comprising:
a first control unit configured to be connected to the first conductive film and the second conductive film, thereby applying a first electric field to the suspended particle layer; and
a second control unit configured to be connected to the third conductive film and the fourth conductive film, thereby applying a second electric field to the polymer dispersed liquid crystal layer.

4. The window film of claim 2, wherein each of the first to fourth conductive films comprises at least one selected from the group consisting of indium zinc oxide (ITO), silver nanowire, aluminum, carbon nanotube (CNT), graphene, PEDOT:PSS, polyaniline, and polythiophene.

5. The window film of claim 1, wherein the suspended particle layer comprises:
a dispersion containing an organic fluid or organic gel; and
suspended particles dispersed in the dispersion.

6. The window film of claim 1, wherein the polymer dispersed liquid crystal layer further comprises a polymer layer and liquid crystals dispersed in the polymer layer.

7. The window film of claim 1, wherein the dye is a mixture of two or more dyes.

8. The window film of claim 1, wherein the dye is an orange dye composed of a mixture of a yellow dye and a red dye.

9. The window film of claim 8, wherein the yellow dye is represented by Formula 1: 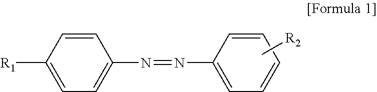
wherein in Formula 1 above, R₁ is —N(CH₃)₂, —N(C₂H₅)₂, or —N(X)₂. The X is an alkyl chain having 3 or more carbon atoms, and in Formula 1 above, R₂ is —H, —CH₃, —C₂H₅, a linear alkyl group having 3 or more carbon atoms, a branched alkyl group having 3 or more carbon atoms, a linear alkene having 3 or more carbon atoms, a branched alkene having 3 or more carbon atoms, or one or more aromatic groups.

10. The window film of claim 8, wherein the red dye is represented by Formula 2 or Formula 3: 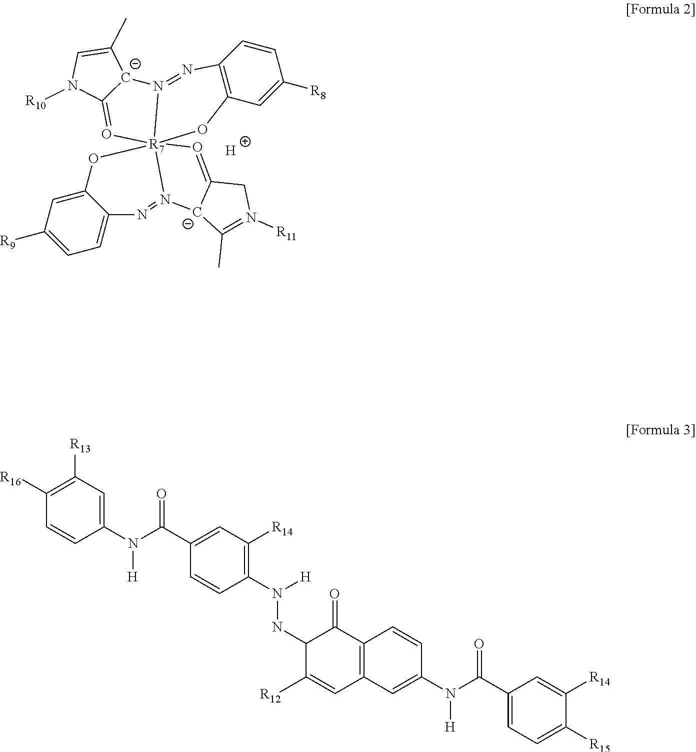
wherein in Formula 2 above and Formula 3 above, R₇ is one among Cr, Mo, W, Mn, V, Nb, and Ta, R₈ R₉ R₁₀, and R₁₁ are each independently —NO₂, —NH₃, —NHCH₃, —NC₄H₁₀, —NC₂H₆, —N (an alkyl chain having 3 or more carbon atoms), or one or more aromatic groups, R₁₂ is either —SO₃Na or —SO₃H, R₁₃ is either —COOH or —COONa, R₁₄ and R₁₅ are each independently —H, —CH₃, —C₂H₅, or one among an alkyl group having 3 or more carbon atoms, a branched alkyl group having 3 or more carbon atoms, a linear alkene having 3 or more carbon atoms, a branched alkene having 3 or more carbon atoms, —NC₄H₁₀, —NC₂H₆, —NHCH₃, —NH₂, —N (an alkyl chain having 3 or more carbon atoms), and one or more aromatic group, and R₁₆ is one among —H, —OH, —SO₃H, and —COOH.

11. The window film of claim 8, wherein the composition ratio of the orange dye, which is composed of the mixture of the yellow dye and the red dye, is 0.01 wt % to 10 wt % of the liquid crystals.

12. A method for operating a window film, wherein
the window film includes:
a first film;
a second film spaced apart from the first film;
a third film interposed between the first film and the second film;
a suspended particle layer between the first film and the third film; and
a polymer dispersed liquid crystal layer between the second film and the third film, and
the method comprises:
a first step of controlling the application of a first electric field to the suspended particle layer; and
a second step of controlling the application of a second electric field to the polymer dispersed liquid crystal layer.

13. The method of claim 12, wherein:
the first electric field is applied in the first step;
the second electric field is applied in the second step; and
the window film is controlled to be transparent.

14. The method of claim 12, wherein:
the first electric field is applied in the first step;
the second electric field is not applied in the second step; and
the window film is controlled to be opaque or translucent in a second color.

15. The method of claim 12, wherein:
the first electric field is not applied in the first step;
the second electric field is applied in the second step; and
the window film is controlled to be opaque or translucent in a first color.

16. The method of claim 12, wherein:
the first electric field is not applied in the first step;
the second electric field is not applied in the second step; and
the window film is controlled to be opaque or translucent in a black color.
